(19) United States
(12) Patent Application Publication
(10) Pub. No.: US 2007/0237382 A1
(43) Pub. Date: Oct. 11, 2007

(54) Method and apparatus for optically monitoring moving objects

(75) Inventors: Achim Nuebling, Emmendingen (DE); Thomas Schopp, Freiburg (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SICK AG, Waldkirch (DE)

(21) Appl. No.: 11/732,862

(22) Filed: Apr. 4, 2007

(30) Foreign Application Priority Data
Apr. 11, 2006 (DE) 102006017337.6

(51) Int. Cl. G06K 9/00

(52) U.S. Cl. 382/141

(57) ABSTRACT

An object is optically evaluated by moving it in a transport direction through the detection zone of an analyzing unit. A first sensor optically determines at least one of a position of the object, a shape of the object, and a brightness or a contrast value of light remitted by the object. Areas of the object which are at least one of interest and of no interest are identified and the at least one of the areas of interest or of no interest are transmitted to a second optical sensor of the analyzing unit. The analyzing unit works the object and senses the areas of interest with a higher resolution than the areas of no interest.

### RELATED APPLICATIONS

This application claims priority from German patent application No. 10 2006 017 337.6 dated Apr. 11, 2006, which is incorporated herein by reference.

### BACKGROUND OF THE INVENTION

This invention concerns a method for obtaining data relating to an object which moves in a transport direction through a detection zone of an optical evaluating unit, especially an optical scanner, and to an apparatus for practicing the method.

Such systems and processes may, for example, use camera arrangements for recording picture data, and it is often necessary to evaluate the data in real time or with very high speed. As a result, the required evaluation systems must have a large computing capacity, which is costly. To reduce the needed computing capacity, it is known to employ a preliminary processing step prior to the actual evaluation of the recorded picture data which identifies those areas of the recorded picture which are of particular interest. Such areas of interest are typically referred to as “regions of interest” (ROI).

Since the ROIs are defined in the preliminary processing step, the evaluation circuit can be limited to only process the picture data of the ROIs. This correspondingly reduces the needed computing capacity as compared to the computing capacity required for processing the entire picture that was recorded by the optical sensor or the camera.

In accordance with the prior art, the ROIs are determined by preprocessing the complete, recorded picture data. Due to the high volume of picture data, simple algorithms are applied which, for example, only determine whether the grey value of a pixel is above a predetermined threshold value. When this is the case, the evaluated pixel is assigned to an ROI; otherwise it is dropped and not further taken into consideration.

Amongst others, such algorithms have the disadvantage that the applicable conditions, in the preceding example exceeding the threshold value, are not always reliably fulfilled. For example, an object of interest that is to be captured is not necessarily always brighter than the background or surroundings of the object. In such cases, the above-mentioned algorithms cannot be used, or can only be used to a limited extent. A further significant disadvantage of such prior art arrangements is that the determination of the ROIs needs the complete picture data. For this, the entire object must be captured with a sufficiently high resolution. After the ROIs have been identified, the remainder of the picture data is of no interest and can be disposed of.

In other instances, sensitive objects are worked on with gripping devices of a robot. The precise points of contact between the gripping device are needed, and this can be effected, for example, by optically capturing the object. This in turn requires that the object be optically accurately captured, an evaluation of the picture data, and forwarding the optical information to the robot. As a result, the data stream for the optical data is normally very high.

### SUMMARY OF THE INVENTION

It is therefore an object of the present invention to provide an improved method for optically capturing objects and an apparatus for practicing the invention, both of which permit a fast data transmission and reduce the required computing capacity and time for optically capturing the object.

Thus, the method of the present invention generally involves the following steps that are performed on objects in the detection zone of an analyzing unit:
moving the object in a transport direction through the detection zone,
with a first sensor optically determining at least one of a position of the object, a shape of the object, and a brightness or a contrast value of light remitted by the object,
determining areas of the object which are at least one of interest and of no (or at least lesser) interest,
transmitting the at least one of the areas which are of interest and of no interest to a second optical sensor of the analyzing unit, and
with the analyzing unit, working the object, including sensing the areas of interest with a higher optical resolution than the areas of lesser or no interest.

The present invention has the important advantage that as soon as the position and/or shape of the object and/or the brightness or contrast values of light remitted by the object have been captured or obtained, the object surface can be divided into areas of interest and areas of no interest. As a result, only position data for areas of interest need to be transmitted to the analyzing unit for further processing. The volume of the data stream is thereby significantly reduced. As a result of the initial selection of the areas of interest, the optical information needed for the actual evaluation can be completed much faster and with less computation time, because only the areas of interest of the object are captured at a higher resolution than the areas of no interest. The present invention therefore permits one to focus the computation time on the evaluation of the areas of interest.

To capture the areas of interest of the object with greater resolution, the second optical sensors capture or sense the areas of interest with a higher resolution than the areas of no interest. The second optical sensor is therefore adapted to work with different degrees of resolution, depending on which area is in its field of view.

To capture the areas of interest of the object with greater resolution, the second optical sensor can alternatively capture the object with a constant optical resolution. However, the captured picture data are evaluated by the second optical sensor, or by an evaluation unit associated with it, by relatively more thoroughly evaluating the areas of interest than the areas of no interest. Such an evaluation can involve, for example, a line-by-line recordation of picture data and evaluating all lines for areas of interest, while for areas of no interest only a portion of the lines, for example each third line, or none of the lines for these areas are evaluated.

In a presently preferred embodiment of the invention, the second sensor optically continuously captures the object with the highest possible resolution but evaluates the captured data more thoroughly only for the areas of interest while the data for the areas of no interest is only incompletely evaluated. In the end, only the areas of interest have a relatively higher resolution. Since the computation time for processing the data captured by the sensor requires more time than sensing the data with the second sensor, time is saved and this embodiment is preferred. In accordance with the invention, the data for the areas of no interest are therefore discarded and the required computation time is significantly reduced.

The areas of interest and of no interest can be distinguished in a variety of ways based on different criteria. As a first example, the areas of interest can be determined from the position and geometric shape of the object. For example, when the object is a rectilinear package the shape of which needs to be precisely captured, the corner areas of the package are of higher interest than the continuously extending side edges. As a further example, the area of interest can be formed by a label which carries a bar code. Such a label can frequently be identified based on the brightness or contrast value of the remitted light. The position and extent of the area of interest determined in this manner are then transmitted to the second optical sensor.

This embodiment has particular time advantages when the second optical sensor and/or a device for working the object are defined by a camera, because picture data always require high computation capacities and computation times. For example, when a bar code reader or an OCR are used, an important time advantage is attained by preclassifying the areas of interest and of no interest.

As demonstrated by the preceding examples, the term “working” the object refers to and includes a multitude of possible alternatives, such as, for example, optically capturing the object for reading or sensing information from the object. The term also includes working the object otherwise such as with a robot, for example gripping the object with a robotic arm or automatically applying a label or the like to the object. The term “working” the object encompasses all such alternatives, as well as others well-known to persons of ordinary skill in the art.

It is preferred to determine the position and/or geometric shape of the object and/or the brightness or contrast value of light remitted by the object at the beginning of the process when the object enters the monitored area or detection zone of the analyzing unit, so that the monitored object surfaces can be immediately categorized into areas of interest and areas of no interest.

In an already partially discussed embodiment of the invention, the second optical sensor is a scanning unit which optically captures the object line-by-line. Here it is advantageous to scan the object line-by-line with the first sensor, the lines being oriented transverse to the transport direction for determining its position and/or geometric form of the object. The scanning unit which forms the second sensor also scans the object line-by-line transversely to the transport direction. However, the lines scanned by the first sensor do not necessarily have to be parallel to the orientation of the second sensor because the information concerning the areas of interest is transmitted on the basis of the position of the object in a common coordinate system.

When the first and second sensors have approximately parallel scanning directions so that the lines recorded by them are approximately parallel also, the differentiation between areas of interest and of no interest becomes quite simple. After the first sensor has captured the entire object, only selected line positions are transmitted to the scanning unit or its associated evaluation unit. Then, the lines from the second sensor are only evaluated at preselected positions, e.g. at multiple line spacings intervals.

The present invention is further directed to an apparatus which has a detection zone for optically evaluating an object. The apparatus has a conveyor for transporting the object through the detection zone and a first sensor for determining at least one of a position of the object, a shape of the object, and at least one of a brightness value and a contrast value of light remitted by the object. The apparatus includes an arrangement that locates areas of the object which are at least one of interest and of no interest. The areas of interest are sensed with a higher resolution than areas that are of no interest.

The first sensor is preferably a laser scanner. The object is captured by the laser scanner along a scan line so that, when the scan lines are oriented transverse to the transport direction, the forward movement of the object leads to the complete line-by-line representation of the object from which its position and/or the geometric form of the object is readily determined.

The camera forming the second sensor need not be a line camera with only one receiving line and can, for example, be a CCD camera. A line-by-line capture of the object is also possible with a two-dimensional receiver array, but in such a case the scanning unit requires a lighting source which provides a line-shaped illumination of the object.

In a further alternative, a two-dimensional matrix can be used as the second sensor. The areas of interest and of no interest are defined by the first sensor with differing accuracy/resolution. When such a matrix is used, a flashlight can be employed as the lighting source. The flashlight can be oriented on the basis of information where areas of interest on the object are located, so that the illumination of the areas of interest is optimized so that these areas are optimally lit.

### BRIEF DESCRIPTION OF THE DRAWINGS

FIG. 1 schematically illustrates an arrangement constructed in accordance with the present invention for analyzing external features of objects;

FIG. 2 is a first plan view of an object carried on a conveyor band of the arrangement; and

FIG. 3 is a second plan view of an object on a conveyor band.

### DESCRIPTION OF THE PREFERRED EMBODIMENTS

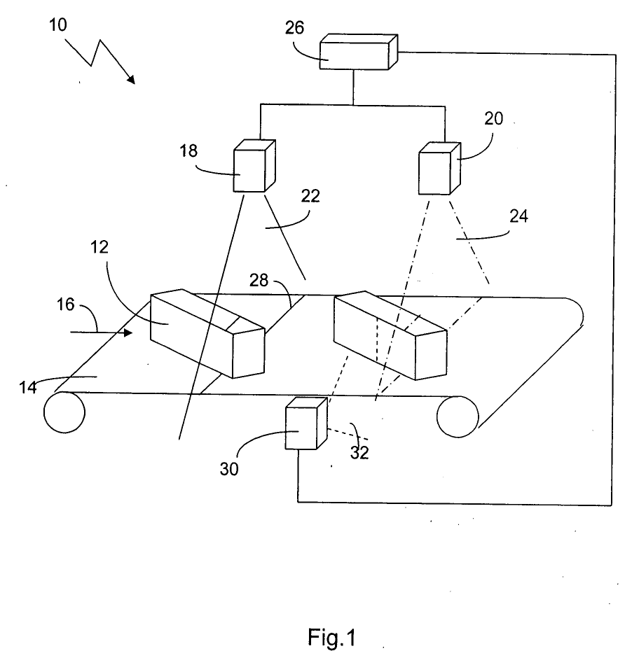

The embodiment of the present invention described herein concerns its use with a camera. FIG. 1 shows the arrangement 10 of the present invention in which an object 12 carried on a conveyor belt 14 is moved in the transport direction indicated by arrow 16. Above the conveyor belt 14 are a laser scanner 18 and a line camera 20 which are sequentially arranged in transport direction 16.

Laser scanner 18 is a line scanner that is capable of periodically emitting laser beams within a sensing plane 22. Sensing plane 22 may, for example, extend perpendicular to transport direction 16. Relative to conveyor belt 14, laser scanner 18 is positioned so that the emitted laser beams scan slightly past the width of conveyor belt 14 so that all objects which are located on the belt will be captured by the laser scanner.

The first line camera 20 has a generally V-shaped field of view in plane 24 for completely scanning all objects on conveyor belt 14 which move past the line camera. Plane 24 of the field of view of line camera 20 can be parallel to sensing plane 22 of laser scanner 18 and perpendicular to transport direction 16. However, it is not a necessity that the two are parallel to each other.

A second line camera 30 is arranged on the side of conveyor belt 14. It has a sensing plane that is perpendicular to conveyor belt 14 and which is adapted to scan object 12 from the side of the belt. In a similar manner, additional line cameras can be arranged on other sides of the object so that measuring a multi-sided object becomes possible.

Laser scanner 18 and line cameras 20, 30 are coupled to a control and evaluation circuit 26. The control and evaluation circuit controls the laser scanner and the line cameras as required by the present invention. In addition, the control and evaluation circuit sees to it that the data received from laser scanner 18 and line cameras 20, 30 is properly processed and used. The control and evaluation circuit can be a separate, externally located unit. Alternatively, the control and evaluation circuit can be integrated into camera 20, which scans the same side of the object as the laser scanner. The control and evaluation circuit 26 knows the spacing between laser scanner 18 and the transportation plane of conveyor belt 14 relative to those points, as well as where the sensing plane 22 of the laser scanner intersects the transportation plane. The intersection line shown in FIG. 1 carries reference numeral 28.

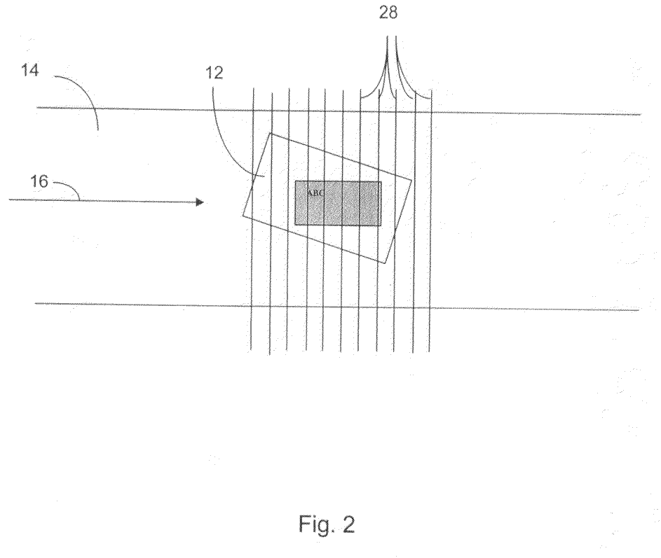

As is schematically shown in FIG. 2, when object 12 moves in transport direction 16 through scanning plane 22, it is captured line-by-line by laser scanner 18. As can be seen in the plan view of FIG. 2, scan lines 28 of laser scanner 18 represent different points in time. They intersect the object at equidistant spacings because the conveyor belt has a constant transport speed. In fact, as already described, it is object 12 which moves past the laser scanner. In this respect, therefore, the illustration of FIG. 2 is not correct, and it is presented only to facilitate the understanding of the present invention. Normally the scan lines are much closer to each other (for example, more than 10 lines per cm) than shown in FIG. 2 due to the very high scanning frequency of the scanner.

Thus, laser scanner 18 and control and evaluation circuit 26 are used to determine the positions of objects on conveyor belt 14 and their orientation and geometry.

The position of line camera 30 can be such that it must read information carried on one side of the object, for example on the front side, at an oblique angle since the front side of the object is obliquely inclined relative to the scanning plane of the camera. For this, the second line camera must pick up the area of interest with high resolution, which especially applies to the resolution in the transport direction 16 and which additionally, for example, may require a rapid focusing or refocusing of the camera. No such high resolution in the transport direction and/or fast adjustment of the focus are necessary in the central part of the object.

In accordance with the present invention, the first sensor 18 determines the position and/or the geometric shape of object 12 and/or the brightness and contrast values of light reflected by the object, and from that it determines areas of interest and no interest. In the embodiment described herein, the area of interest is the front side of the object. Information is therefore transmitted by scanning unit 18 to line cameras 20, 30 and/or the control and evaluation unit 26 that the front side of the object requires higher resolution. This can be done because the position of the front side of the object on the conveyor belt and where it intersects the scan lines generated by line cameras 20, 30 can be determined from the known transport speed of the conveyor belt. Accordingly, the first sensor 18 transmits the position of areas which are of interest and of no interest to the control and evaluation unit, which uses the information for evaluating the picture data generated by camera 20. Since this involves position data, sensors 18 and 20 must use a common coordinate system.

The line cameras capture the object 12 moving past them with constant high optical resolution. In other words, the scanning frequency of the line camera with which the object is scanned as it moves past it remains constant. In the area of interest, that is, the front side in the foregoing example, all recorded lines are evaluated to generate a high resolution picture, but in areas of little or no interest, only a portion of the lines, for example every third or tenth line, is evaluated, so that, in these areas, the optical resolution is lower. In this manner, the amount of data needed for processing the lines recorded by the line cameras is significantly less, which substantially reduces processing and calculating times.

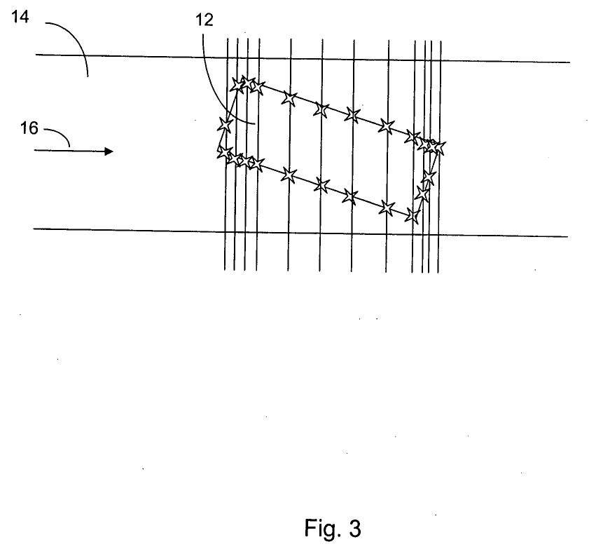

Such a line-by-line scanning of the object with high and low resolution as a function of the position of the object is shown in FIG. 3. FIG. 3 is similar to FIG. 2 but shows the lines which are evaluated. In the areas of interest, the density of the lines is greater (higher resolution) than in the areas of little or no interest.

Before evaluating the line camera output, the laser scanner transmits information to the line cameras that indicates the positions of lines generated by the line camera which require consideration and analysis for capturing the object line-by-line. This results in a reduction of information that must be processed to only that which is most needed and therefore requires only a relatively small transmission capacity from the laser scanner to the control and evaluation unit and/or the line camera. In such a case, the line cameras themselves do not have to differentiate between areas of interest and areas of no interest, which saves valuable time. The full computing capacity can therefore be used for evaluating the pictures, particularly for areas of interest.

The areas of interest can be at different areas or portions of the object. For example, one area of interest can be on the top surface of the object in the form of an adhesively applied label which carries a bar code that is to be read by the camera. Further, a matrix camera can be used for reading bar codes. The first sensor can, for example, determine the different light intensity of the label and that it is positioned on the top surface of the object. Corresponding position data is then sent from the first sensor to the control and evaluation unit. The continually moving object then passes the field of view of the matrix camera, which takes a picture of the top surface of the object and transmits it to the control and evaluation circuit. The control and evaluation circuit has information concerning the position of the label so that the reported picture needs a high resolution evaluation only in the area of the label for properly reading the bar code on the label. The remainder of the picture can be discarded.

What is claimed is:

1. A method for optically evaluating an object which moves past a detection zone of an analyzing unit comprising
moving the object in a transport direction through the detection zone,
with a first sensor optically determining at least one of a position of the object, a shape of the object, and a brightness or a contrast value of light remitted by the object,
locating areas of the object which are at least one of interest and of no interest,
transmitting the at least one of the areas which are of interest and of no interest to a second optical sensor of the analyzing unit, and
with the analyzing unit, working the object, including sensing the areas of interest with a higher resolution than the areas of no interest.

2. A method according to claim 1 wherein the second sensor continuously senses the object with a constant resolution, and including evaluating data from areas of interest sensed by the second optical sensor more completely than data from areas of no interest.

3. A method according to claim 1 wherein sensing the areas of interest comprises with the second optical sensor recording the areas of interest of the object with greater resolution than areas of no interest.

4. A method according to claim 1 wherein the areas of interest are located on the basis of at least one of an orientation of the object, a shape of the object, and the brightness and/or contrast value of the light remitted by the object.

5. A method according to claim 4 wherein the at least one of the position of the object, the shape of the object, and the brightness and/or contrast values of light remitted by the object are determined at a beginning of the detection zone of the analyzing unit.

6. A method according to claim 1 wherein the areas of interest form geometric boundary areas of the object and are located on at least one of a front side and a back side of the object relative to the transport direction.

7. A method according to claim 1 wherein the analyzing unit includes a robot adapted to working on the areas of interest.

8. A method according to claim 7 wherein the robot applies a label to the area of interest.

9. A method according to claim 2 wherein the first sensor senses the object along lines which are transverse to the transport direction for determining at least one of the position of the object and the shape of the object, and including a second sensor for also sensing the object line-by-line.

10. A method according to claim 9 wherein, after the first sensor generated scan lines for the entire object, transmitting only selected ones of the scan lines to a second sensor, and wherein only data from the selected scan lines are further evaluated.

11. Apparatus having a detection zone for optically evaluating an object comprising
a conveyor for transporting the object through the detection zone,
a first sensor for determining at least one of a position of the object, a shape of the object, and at least one of a brightness and a contrast value of light remitted by the object,
an arrangement for locating at least one area of the object which is at least one of being of interest and of being of no interest, and
a system sensing the areas of interest with a higher resolution than areas of no interest.

12. Apparatus according to claim 11 including a device for working the object.

13. Apparatus according to claim 11 wherein the arrangement comprises a second optical sensor.

14. Apparatus according to claim 11 wherein the first sensor comprises a laser scanner.

15. Apparatus according to claim 11 wherein the second sensor is a scanning unit and includes a light source which linearly illuminates the object.

16. Apparatus according to claim 15 wherein the scanning unit comprises a line camera.

17. Apparatus according to claim 11 wherein the second sensor is a two-dimensional matrix camera.

18. Apparatus according to claim 17 wherein the matrix includes a light source with a control unit for preferentially directing light from the light source towards the areas of interest.

19. Apparatus according to claim 18 wherein the light source comprises a flashlight.
